(19) United States
(12) Patent Application Publication
(10) Pub. No.: US 2025/0170837 A1
(43) Pub. Date: May 29, 2025

(54) PRINTING APPARATUS, METHOD OF CONTROLLING PRINTING APPARATUS, AND COMPUTER-ACCESSIBLE RECORDING MEDIUM CONTAINING COMPUTER-EXECUTABLE INSTRUCTIONS FOR PRINTING APPARATUS

(71) Applicant: BROTHER KOGYO KABUSHIKI KAISHA, Nagoya (JP)

(72) Inventor: Shingo SAITO, Nagoya (JP)

(21) Appl. No.: 18/961,992

(22) Filed: Nov. 27, 2024

(30) Foreign Application Priority Data
Nov. 28, 2023 (JP) 2023-200687

(51) Int. Cl. B41J 11/66; B41J 11/70; B41J 15/04; B41M 5/00

(52) U.S. Cl. CPC B41J 11/663; B41J 11/70; B41J 15/046; B41M 5/0011

(57) ABSTRACT

A printing apparatus comprises a supply tray, a head having nozzles, a moving device configured to move the head, a conveying device, a cutter, and a controller. The controller performs a first printing process including a first pass operation to eject ink while moving the head and a first conveyance operation to convey the printing medium by a first conveyance amount. A first pass area of the printing medium in a current recording process overlaps the first pass area in a previous recording process. The controller is configured to perform a cutting process of cutting the printing medium, and a correction process of correcting the first conveyance amount in such a manner that a downstream end of the first pass area faces a downstream end of the nozzle range. The cutter is configured to cut the printing medium after the correction process is performed.

### REFERENCE TO RELATED APPLICATIONS

This application claims priority from Japanese Patent Application No. 2023-200687 filed on Nov. 28, 2023. The entire content of the priority application is incorporated herein by reference.

### BACKGROUND ART

The present disclosure relates to a printing apparatus, a method of controlling the printing apparatus, and a computer-accessible recording medium containing computer-executable instructions for the printing apparatus.

Conventionally, there has been known an image forming apparatus equipped with a cutter mechanism configured to cut a roll sheet, rollers configured to convey the roll sheet, and an image forming device configured to form images on the roll sheet.

### SUMMARY

For example, when the image forming device has a serial type printing head, the image forming apparatus is typically configured to alternately perform a conveying operation to convey the roll sheet in a conveying direction, and a pass operation in which a head is moved in a direction intersecting with a conveying direction of the roll sheet while ink droplets are ejected from the head. If the cutter mechanism is driven to cut the roll sheet when the conveying operation is performed, the conveying operation of the roll sheet must be interrupted to perform a cutting operation. In such a case, a conveying amount of the roll sheet after the cutting operation may be smaller than it should be, and conveyance accuracy of the rollers may be degraded. Due to such degradation of the conveyance accuracy, images printed by respective pass operations may be misaligned with each other, resulting in banding (i.e., uneven patterns or stripes occurred in printed images).

According to aspect of the present disclosures, there is provided a printing apparatus, comprises a supply tray configured to supply a printing medium, a head having an ejection surface including a nozzle range in which a plurality of nozzles configured to eject ink toward the printing medium are arranged, a moving device configured to move the head in a moving direction, a conveying device configured to convey the printing medium along a conveying direction which intersects with the moving direction, a cutter arranged closer to the supply tray with respect to the head, the cutter being configured to cut the printing medium, and, a controller. The controller is configured to perform a first printing process of repeatedly executing a recording process including a first pass operation and a first conveyance operation, the first pass operation being an operation of causing the plurality of nozzles to eject ink to a first pass area of the printing medium while causing the moving device to move the head along the moving direction, the first conveyance operation being an operation of causing the conveying device to convey the printing medium by a first conveyance amount less than or equal to a dimension of the nozzle range in the conveying direction, a part of a first pass area subject to the first pass operation in a current recording process overlapping a part of the first pass area subject to the first pass operation in a previous recording process, a cutting process of cutting the printing medium by the cutter, and a correction process of correcting the first conveyance amount in the first printing process in such a manner that a downstream end of the first pass area in the conveying direction faces a downstream end of the nozzle range in the conveying direction when performing the cutting process. The cutter is configured to cut the printing medium after the correction process is performed.

According to aspect of the present disclosures, there is provided a method of controlling a printing apparatus. The printing apparatus comprises a supply tray configured to supply a printing medium, a head having an ejection surface including a nozzle range in which a plurality of nozzles configured to eject ink toward the printing medium are arranged, a moving device configured to move the head in a moving direction, a conveying device configured to convey the printing medium along a conveying direction which intersects with the moving direction, a cutter arranged closer to the supply tray with respect to the head, the cutter being configured to cut the printing medium, and a controller. The method of controlling the printing apparatus comprises a first printing process of repeatedly executing a recording process including a first pass operation and a first conveyance operation, the first pass operation being an operation of causing the plurality of nozzles to eject ink to a first pass area of the printing medium while causing the moving device to move the head along the moving direction, the first conveyance operation being an operation of causing the conveying device to convey the printing medium by a first conveyance amount less than or equal to a dimension of the nozzle range in the conveying direction, a part of a first pass area subject to the first pass operation in a current recording process overlapping a part of the first pass area subject to the first pass operation in a previous recording process, a cutting process of cutting the printing medium by the cutter, and a correction process of correcting the first conveyance amount in the first printing process in such a manner that a downstream end of the first pass area in the conveying direction faces a downstream end of the nozzle range in the conveying direction when performing the cutting process. The cutting process is executed after the correction process is performed.

According to aspect of the present disclosures, there is provided a non-transitory computer-readable recording medium containing computer-executable instructions that are executable by a controller of a printing apparatus. The printing apparatus comprises a supply tray configured to supply a printing medium, a head having an ejection surface including a nozzle range in which a plurality of nozzles configured to eject ink toward the printing medium are arranged, a moving device configured to move the head in a moving direction, a conveying device configured to convey the printing medium along a conveying direction which intersects with the moving direction, and a cutter arranged closer to the supply tray with respect to the head, the cutter being configured to cut the printing medium. The computer-executable instructions is configured to, when executed by the controller, cause the printing apparatus to perform a first printing process of repeatedly executing a recording process including a first pass operation and a first conveyance operation, the first pass operation being an operation of causing the plurality of nozzles to eject ink to a first pass area of the printing medium while causing the moving device to move the head along the moving direction, the first conveyance operation being an operation of causing the conveying device to convey the printing medium by a first conveyance amount less than or equal to a dimension of the nozzle range in the conveying direction, a part of a first pass area subject to the first pass operation in a current recording process overlapping a part of the first pass area subject to the first pass operation in a previous recording process, a cutting process of cutting the printing medium by the cutter, and a correction process of correcting the first conveyance amount in the first printing process in such a manner that a downstream end of the first pass area in the conveying direction faces a downstream end of the nozzle range in the conveying direction when performing the cutting process. The cutting process is executed after the correction process is performed.

### BRIEF DESCRIPTION OF DRAWINGS

FIG. 1 is a cross-sectional side view of a printing apparatus according to the present disclosure, viewed from a left side thereof.

FIG. 2 is a block diagram showing a configuration of the printing apparatus.

FIG. 3 shows a positional relationship between a nozzle area of a head and a printing medium according to a first embodiment when a first conveying amount of the printing apparatus is not compensated.

FIG. 4 is a part of FIG. 3 and shows the positional relationship between a nozzle area of the head and a printing area of the printing medium.

FIG. 5A shows a positional relationship between the nozzle area of the head and the printing medium.

FIG. 5B is a graph showing a dot formation ratio of a first pass operation of a first cycle.

FIG. 5C is a graph showing the dot formation ratio of a first pass operation of a second cycle.

FIG. 5D is a graph showing the dot formation ratio of a first pass operation of a third cycle.

FIG. 5E is a graph showing the dot formation ratio of a first pass operation of a fourth cycle.

FIG. 6 shows a pixel area “1” of the printing medium in which dots are formed by the first pass operation of the first cycle.

FIG. 7 shows a pixel area “2” of the printing medium in which dots are formed by the first pass operation of the second cycle.

FIG. 8 shows a pixel area “3” of the printing medium in which dots are formed by the first pass operation of the third cycle.

FIG. 9 shows a pixel area “4” of the printing medium in which dots are formed by the first pass operation of the fourth cycle.

FIG. 10 shows a positional relationship between the nozzle area of the head and the printing medium when the first conveying amount in the first printing process has been compensated.

FIG. 11 is a flowchart illustrating an example of a control method of the printing apparatus according to the present embodiment.

FIG. 12 shows a positional relationship between the nozzle area of the head and the printing medium when the first conveying amount is not compensated according to the modified embodiment.

FIG. 13A shows a positional relationship between the nozzle area of the head and the printing medium.

FIG. 13B is a graph showing a dot formation ratio of a first pass operation of a first cycle.

FIG. 13C is a graph showing the dot formation ratio of a first pass operation of a second cycle.

FIG. 13D is a graph showing the dot formation ratio of a first pass operation of a third cycle.

FIG. 13E is a graph showing the dot formation ratio of a first pass operation of a fourth cycle.

FIG. 14 shows a positional relationship between the nozzle area of the head and the printing medium when the first conveying amount in the first printing process has been compensated.

FIG. 15 is a flowchart illustrating an example of a control method of the printing apparatus according to the modified embodiment.

### DESCRIPTION

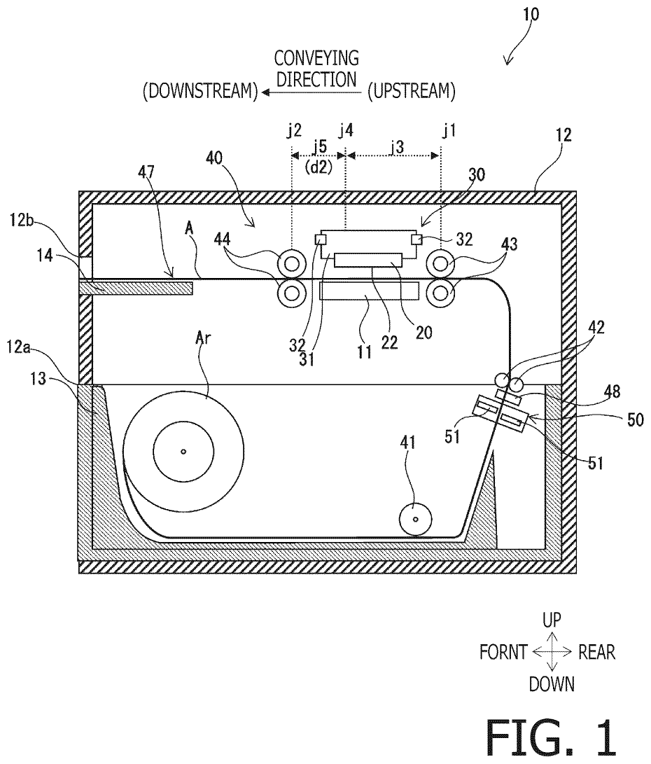

As shown in FIG. 1, a printing apparatus 10 according to an embodiment is a serial head type inkjet printer configured such that a head 20 is moved in a moving direction, while ink droplets are ejected toward a printing medium A. The printing medium A is an elongated sheet type medium configured to be wound as roll body Ar. That is, when printing is executed, the printing medium A is drawn (unwound) from the roll body Ar, the printing is executed on the drawn (unwound) part of the printing medium A. As the sheet type medium, paper, fabric, a label sheet, and the like are used.

In the following description, a moving direction of the head 20 is referred to as a right-left direction, and a conveying direction, which intersects (e.g., orthogonally) with a conveying direction of the printing medium A at a position facing the head 20, is referred to as a front-rear direction. Further, a direction intersecting (e.g., orthogonal to) with the moving and conveying directions is referred to as the up-down direction. It should be noted, however, the directions with respect to the printing apparatus 10 are not limited to this, but may be defined in a different way.

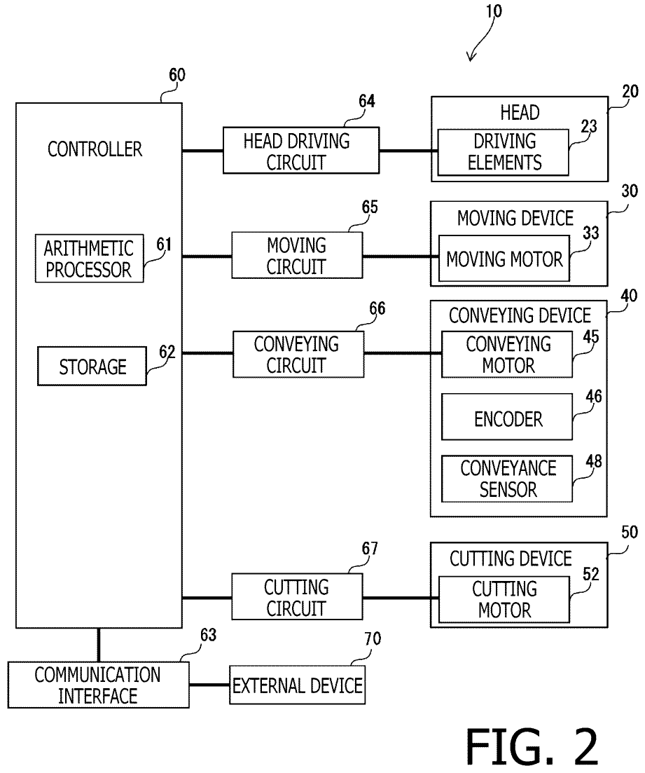

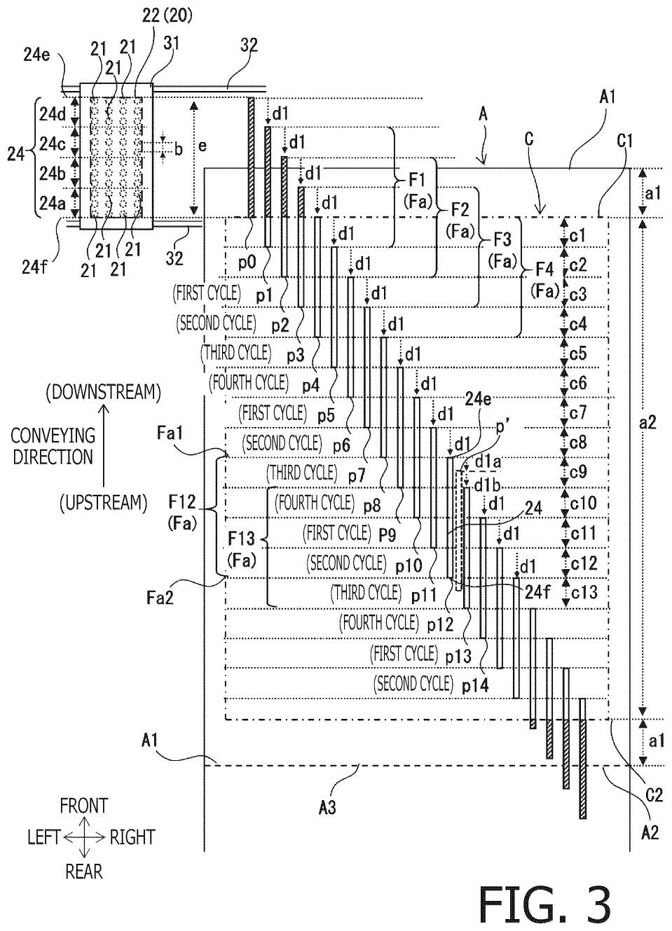

The printing apparatus 10 has a head 20 and a platen 11. The head 20 has an ejection surface 22 on which multiple nozzles 21 are formed (see FIG. 3), and multiple driving elements 23 for respective nozzles 21 (see FIG. 2). For example, piezoelectric elements, resistive heating elements, or electrostatic actuators are provided as drive elements 23 at respective nozzles 21 to apply ejection pressure to the ink in the ejection head 20. The platen 11 is arranged below the head 20. The platen 11 has an upper surface facing the ejection surface 22, which is a lower surface of the head 20. The platen 11 supports the printing medium A arranged on the upper surface of the platen 11 from below. The head 20 will be described in detail later.

Further, the printing apparatus 10 has a moving device 30 configured to move the head 20 in the right-left direction (i.e., in a direction orthogonal to a plane of FIG. 1). The moving device 30 has a carriage 31, two rails 32 and a moving motor 33 (see FIG. 2). The two rails 32 are arranged separately in the front-rear direction and extend parallelly in the right-left direction. The carriage 31 mounts the head 20 on the lower surface thereof, and is supported by the two rails 32 so as to be movable in the right-left direction. As the moving motor 33 is driven, the carriage 31 and the head 20 move in the right-left direction above the platen 11.

The printing apparatus 10 has a housing 12 accommodating the head 20, a supply tray 13 and a discharge tray 14. The housing 12 has a hollow solid rectangular shape. A lower opening 12a and an upper opening 12b, which is formed on an upper side with respect to the lower opening 12a, are formed on a front wall of the housing 12. The housing 12 has an interior space, in which the head 20 is arranged. The supply tray 13 is configured to supply the printing medium A to the head 20. The supply tray 13 accommodates a cylindrical roll body Ar such that a central axis of the cylindrical roll body Ar extends in the right-left direction. The supply tray 13 is provided on a lower side in the interior space of the housing 12 in such a manner that the supply tray 13 can be attached to and detached from the housing 12 through the lower opening 12a. The discharge tray 14 is arranged above the supply tray 13 at the upper opening 12b in such a manner that the printing medium A on which printing has been executed by the head 20 is discharged from the housing 12.

The printing apparatus 10 has a conveying device 40 configured to convey the printing medium A in the conveying direction. The conveying device 40 has a supply roller 41, a guide roller pair 42, an upstream roller pair 43, a downstream roller pair 44, and a conveying motor 45 (see FIG. 2). The supply roller 41 and each roller of the guide roller pair 42, the upstream roller pair 43, and the downstream roller pair 44 has a rotation axis extending in the right-left direction.

Each of the supply roller 41, one roller of the guide roller pair 42, one roller of the upstream roller pair 43, and one roller of the downstream roller pair 44 is a driving roller, which is configured to rotate about the rotation axis when the conveying motor is driven to rotate. The other roller of the guide roller pair 42, the other roller of the upstream roller pair 43, and the other roller of the downstream roller pair 44 is a driven roller that rotates in association with the corresponding driving roller. It is noted that the driving roller of the supply roller pair 41, the driving roller of the guide roller pair 42, the driving roller of the upstream roller pair 43 and the driving roller of the downstream roller pair may be connected to the same conveying motor 45, or different conveying motors 45, respectively.

The supply roller 41 is arranged above the supply tray 13 and is configured to feed the printing medium A withdrawn from the roll body Ar rearward. The guide roller pair 42 is arranged between the supply roller 41 and the head 20 in the up-down direction, while arranged rearward with respect to the supply roller 41 and the head 20 in the front-rear direction. The guide roller pair 42 is configured to hold the printing medium A, which has been supplied by the supply roller 41, between the two rollers thereof and to convey the printing medium A upward.

The upstream roller pair 43 is arranged on the upper side, in the up-down direction, with respect to the guide roller pair 42, while the upstream roller pair 43 is arranged on the front side, in the front-rear direction, with respect to the guide roller pair 42. Two rollers 43 of the upstream roller pair 43 are aligned in the up-down direction and hold the printing medium A conveyed by the guide roller pair 43 therebetween to convey the printing medium A forward. The downstream roller pair 44 is arranged on the front side with respect to the upstream roller 43. Two rollers of the downstream roller pair 44 are aligned in the up-down direction and hold the printing medium A conveyed by the upstream roller pair 43 therebetween and convey the printing medium A forward.

In the front-rear direction, the platen 11 is arranged between the upstream roller pair 43 and the downstream roller pair 44, and the discharge tray 14 is formed on the front side with respect to the downstream roller pair 44. Accordingly, in the conveying direction of the printing medium A that is conveyed on the platen 11, the upstream roller pair 43 is arranged on the upstream side with respect to the platen 11, while the downstream roller pair 44 is arranged on the downstream side with respect to the platen 11. The printing medium A is held by the two rollers of the upstream roller pair 43 and conveyed onto the platen 11. On the platen 11, ink droplets are ejected from the head 20. Then, the printing medium A is held by the two rollers of the downstream roller pair 44 and conveyed to the discharge tray 14. In this way, a conveying path 47 of the printing medium A is defined by the supply tray 13, the supply roller 41, the guide roller pair 42, the upstream roller pair 43, the platen 11, the downstream roller pair 44, and the discharge tray 14.

The conveying device 40 has an encoder 46 (see FIG. 2) and a conveyance sensor 48. The encoder 46 is configured to detect a rotation angle and a rotation direction of the conveying motor 45, and outputs detection signals. The conveyance sensor 48 is configured to detect presence or absence of the printing medium A, and a well-known sensor such as a photo sensor may be used as the conveyance sensor 48. The conveyance sensor 48 is arranged upstream with respect to the head 20 in the conveying path 47, that is, the conveyance sensor 48 is arranged closer to the supply tray 13 than the head 20 in the conveying path 47. In the configuration shown in FIG. 1, the conveyance sensor 48 is arranged between the guide roller pair 42 and the supply tray 13 in the conveying path 47. When detecting the printing medium A conveyed along the conveying path 47, the conveyance sensor 48 outputs a detection signal. Based on the detection signals output by the encoder 46 and the conveyance sensor 48, a location of a leading end of the printing medium A is obtained.

The printing apparatus 10 has a cutting device 50 configured to cut the printing medium A. The cutting device 40 includes a cutter 51, and a cutting motor 52 (see FIG. 2) to drive the cutter 51. The cutter 51 is arranged upstream with respect to the head 20 in the conveying path 47. That is, the cutter 51 is arranged closer to the supply tray 13 with respect to the head 20. In the configuration shown in FIG. 1, the cutter 51 is arranged between the conveyance sensor 48 and the supply tray 13.

The cutter 51 includes, for example, two rotating blades that rotate around a rotation axis. Driven by the cutting motor 52, the cutter 51 rotates (i.e., the two rotating blades rotate), while moving in the right-left direction to cut the printing medium A. In this way, as shown in FIG. 3, in the conveying direction of the printing medium A, a trailing end A2, which is an upstream end of the printing medium A downstream of a cutting position A3 (a part of the printing medium subject to printing this time), is formed, and a leading end A1, which is a downstream end of the printing medium A upstream of the cutting position A3 (a part of the printing medium subject to printing next time), is formed.

As shown in FIG. 2, the printing apparatus 10 has a controller 60 configured to control respective components of the printing apparatus 10, and a communication interface 63, a head driving circuit 64, a moving circuit 65, a conveying circuit 66 and a cutting circuit 67, which are electrically connected to the controller 60.

The controller 60 is configured by a computer, which is provided, as hardware, with an arithmetic processor 61 and a storage 62. The arithmetic processor 61 includes a processor such as a CPU, an integrated circuit such as an ASIC, or a combination thereof. The storage 62 is a recording medium accessible by the arithmetic processor 61, and includes, for example, a RAM and a ROM. The storage 62 is configured to store various pieces of data such as print job data, and computer-executable programs causing, when executed by the arithmetic processor 61, the printing apparatus 10 to execute various data processing.

A print job contains image data and a print condition. The image data is data representing an image to be printed. The image data is, for example, raster data composed by a plurality of pixels which divide the image. The print condition includes, for example, a dimension of a margin a1 in the front-rear direction (FIG. 3), a resolution of the image to be printed, and a shingling number. By executing the computer programs with reference to data stored in the storage 62, the arithmetic processor 61 control operations of respective components of the printing apparatus 10. Concepts of “shingling” will be described later. It is noted that the print condition may be a particular condition which has been determined in advance.

The communication interface 63 is a connection device configured to connect the controller 60 to devices 70 external to the printing apparatus 10. The external devices 70 may include other computers, mobile terminals, cameras, external servers, recording media, and the like. The communication interface 63 may be connected to external devices 70 by wired communication using a USB cable or other means, or by wireless communication using LAN or other means. The controller 60 is configured to obtain various data, such as print job data, from external devices 70 via the communication interface 63 and store the data in the storage 62.

The head driving circuit 64 is electrically connected to the driving elements 23 provided to the head 20. The controller 60 generates control signals to drive the driving elements 23 based on the print job and inputs the control signals to the head driving circuit 64. The head driving circuit 64 generates drive signals based on that control signal that is input from the controller 60. As a result, the driving elements 23 are driven based on their driving signals to apply ejection pressures to the ink in the head 20. In this way, ink ejection timings and the sizes of the ejected ink droplets (i.e., volumes of ink droplets) are controlled by the controller 60 based on the print job.

The moving circuit 66 is electrically connected to a moving motor 33 provided to the moving device 30. The controller 60 generates a control signal to drive the moving motor 33 based on the print job and input the control signal to the moving circuit 66. The moving circuit 66 generates a driving signal based on the control signal input from the controller 60. As a result, the moving motor 33 is driven based on the driving signal, and the moving device 30 moves the head 20 in the right-left direction, and stops the head 20 at any position within a movable range of the head 20.

The conveying circuit 65 is electrically connected to the conveying motor 45 provided to the conveying device 40. The controller 60 generates control signals to drive the conveying motor 45 based on the detection signals of the conveyance sensor 48 and encoder 46, based on the print job, and inputs the control signals to the conveying circuit 65. The conveying circuit 65 generates drive signals based on the input control signals. As a result, the conveying motor 45 is driven based on its driving signal, and the conveying device 40 can convey the printing medium A intermittently or continuously from the supply tray 13, below the head 20, and to the discharge tray 14.

The cutting circuit 67 is electrically connected to the cutting motor 52 provided to the cutting device 50. The controller 60 generates control signals to drive the cutting motor 52 based on the print job and input the control signals to the cutting circuit 67. The cutting circuit 67 generates drive signals based on the input control signal. As a result, the cutting motor 52 is driven based on the driving signal, and the cutting device 50 cuts the printing medium A with the cutter 51.

As shown in FIG. 3, multiple nozzle rows (four in the example in FIG. 3) are aligned in the right-left direction on the ejection surface 22 of the head 20. A plurality of nozzles 21 are arranged in each nozzle row, and the plurality of nozzles 21 are aligned in the front-rear direction at a particular pitch b. The pitch b is a dimension of a distance between the centers of two nozzles 21 adjacent to each other along the front-rear direction on the ejection surface 22. Further, on the ejection surface 22, a nozzle range 24 is defined in which the nozzles 21 are arranged. In the front-rear direction, the dimension e of the nozzle range 24 is equal to a dimension of the nozzle row.

As the image is printed by the head 20 on a printing area C of the printing medium A, the printing apparatus 10 executes an alignment process to align the head 20 with the printing area C. In this alignment process, the conveyance sensor 48 detect the leading end A1 of the printing medium A being conveyed along the conveying path 47 and obtains information of the position of the printing medium A based on the detection signals of the conveyance sensor 48 and the encoder 46 of the conveying motor 45. The controller 60 then obtains a position obtained by adding the margin dimension a1 to this leading edge A1 as a downstream end C1 of the printing area C.

The controller 60 causes the conveying device 40 to convey the printing medium A forward in such a manner that an upstream end 24f of the nozzle range 24 on the ejection surface 22 of the head 20 faces the downstream end C1 of the printing area. In other words, the controller 60 cause the conveying device 40 to align the downstream end C1 of the printing area of the printing medium with the upstream end 24f of the nozzle range 24 on the ejection surface 22 of the head in the conveying direction. In this way, in the example shown in FIG. 3, the nozzle range 24 is located at a position p0 with respect to the printing medium A. It should be noted that, in FIG. 3, the location of the nozzle range 24 with respect to the printing medium A along the front-rear direction is schematically represented by a rectangle.

After the alignment process between the nozzle range 24 of the head 20 and the printing area C of the printing medium A is executed, a first printing process is executed to print an image on the printing area C with the ink ejected from the nozzles 21 within the nozzle range 24. In the first printing process, the controller 60 repeats a recording process multiple times. This recording process includes a first pass operation and a first conveyance operation, and the first pass operations and the first conveyance operations are executed alternately in multiple recording processes. The first pass operation is an operation of causing the nozzles 21 to eject ink to a first pass area Fa (the first pass area Fa will be described in detail later) of the printing medium A while causing the moving device 30 to move the head 20 along the moving direction (i.e., the right-left direction). The first conveyance operation is an operation of causing the conveying device 40 to convey the printing medium A by a first conveyance amount less than or equal to a dimension of the nozzle range 24 in the conveying direction.

In FIG. 3, when the nozzle range 24 is positioned at each of the positions p1, p2, p3, . . . with respect to the printing medium A, a first pass operation is executed. This rectangle showing the nozzle range 24 has ranges indicated in white (hereinafter, referred to as white ranges) and ranges indicated in shading (hereinafter, referred to as shaded ranges). The white ranges are ejection ranges where ink is ejected in the first pass operation, and the shaded ranges are non-ejection ranges where ink is not ejected in the first pass operation.

In the first pass operation, the controller 60 causes the head 20 to eject ink from the nozzles 21 of the head 20 onto a first pass area Fa of the printing medium A while moving the head 20 to the right or to the left. In this way, dots are formed in the first pass area Fa, and a first-pass image composed by the dots is formed.

The first pass area Fa is a part of the printing medium A and facing the nozzle range 24 of the head 20 in the first pass operation. Further, the first pass area is an area where ink can be ejected from the nozzles 21 in the nozzle range 24 by one second pass operation. For example, an area F1 is the first pass area Fa subject to the first execution of the first pass operation, and an area F2 is the second pass area Fa subject to the first execution of the first pass operation. In the front-rear direction, the dimension of the first pass area Fa is equal to the dimension e of the nozzle range 24.

In the first conveyance operation, the controller 60 causes the conveying device 40 to conveys the printing medium A forward by a first conveying amount d1 with respect to the head 20. By this conveyance, the current first pass area Fa is shifted backward by the first conveyance amount d1 from the first pass area Fa of the previous first pass operation executed immediately before the current first pass operation. In the example shown in FIG. 3, the first pass area Fa is an area F1 in the first pass operation, and in the second pass operation, an area F2 that is shifted backward from the area F1 by the first conveyance amount d1. Further, the first pass area Fa is an area F3 that is shifted backward by the first conveyance amount d1 from the area F2 in a third first pass operation, and is an area F4 that is shifted backward by the first conveyance amount d1 from the area F3 in a fourth first pass operation.

Due to the shift of the first pass area Fa, a first pass image formed in the first pass area Fa by the current first pass operation is shifted backward from the first pass image formed in the first pass area Fa by the previous first pass operation by the first conveyance amount d1. In this way, through the first printing process, multiple first-pass images are formed with shifted backward, and the image composed of these images is finally printed on the printing medium A.

The first conveying amount d1 is less than or equal to the dimension e of the nozzle range 24 of the head 20 in the front-rear direction, and is less than the dimension e when the first printing process is executed in a multi-pass method. According to a multi-pass first printing process, a part of the first pass area Fa subject to the current first pass operation overlaps a part of the first pass area Fa subject to the previous first pass operation.

The first conveying amount d1 is determined, for example, by the resolution of the head 20 (i.e., the maximum resolution realized by printing with the head 20, and, for example, the resolution is depending on density of the number of nozzles), the resolution of the image and the shingling number. In the example shown in FIG. 3, the resolution of the head 20 is 300 dpi, the resolution of the image is 600 dpi, and the shingling count is 2. In such a case, the first conveying amount d1 is the sum of one-fourth of the dimension e of the nozzle range 24 and one-half of the pitch b of the nozzle 21 (i.e., e/4+b/2).

A pass cycle of the multi-pass method is the resolution of the image/the resolution of the head 20 x the shingling number, and the pass cycle in the example in FIG. 3 is 600/300× 2=4. Therefore, the printing area C overlaps the first pass image from the first pass operation of four cycles. In the bidirectional printing, the first pass operation in the first and third cycles ejects ink from the nozzles 21 while the head 20 is moved to one of the right and left directions, and the first pass operation in the second and fourth cycles ejects ink from the nozzles 21 while the head 20 is moved to the other of the right and left directions.

In the first printing process, multiple first pass operations are executed. Among the multiple first pass operations, the (4n-3)-th (n being a natural number) first pass operation is in the first cycle, the (4n-2)-th first pass operation is in the second cycle, the (4n-1)-th first pass operation is in the third cycle, and the 4n-th first pass operation is in the fourth cycle.

In accordance with the four cycles of first pass operations, the nozzle range 24 includes a first range 24a, a second range 24b, a third range 24c, and a fourth range 24d aligned in the front-rear direction, and the printing area C includes multiple partial areas c1, c2, c3, . . . , aligned in the front-rear direction. In the multiple partial areas c1, c2, c3, . . . , a first-pass image formed by ink ejected from the nozzles 21 in the first range 24a in a first pass operation of the first cycle, a first-pass image formed by ink ejected from the nozzles 21 in the second range 24b in a first pass operation of the second cycle, a first-pass image formed by ink ejected from the nozzles 21 in the third range 24c in a first pass operation of the third cycle, and a first-pass image formed by ink ejected from the nozzles 21 in the fourth range 24d in a first pass operation of the fourth cycle are superimposed, respectively.

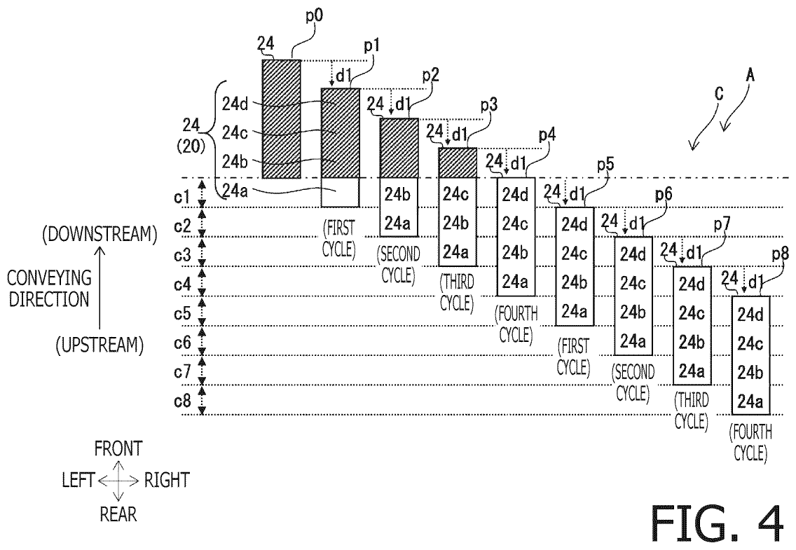

Concretely, as shown in FIG. 4, which is a partially enlarged view of FIG. 3, the nozzle range 24 of the head 20 is located at a position p0 with respect to the printing medium A by the alignment process. Then, in the first conveyance operation of the first printing process, the printing medium A is conveyed forward by the first conveyance amount d1, and the nozzle range 24 is located at a position p1 relative to the printing medium A. With the nozzle range 24 located at the position p1, in the first pass operation of the first cycle, ink is not ejected from the nozzles 21 in the second range 24b through the fourth range 24d, but ink is ejected from the nozzles 21 in the first range 24a. In this way, a first-pass image is formed in the partial print area c1 of the printing area C that faces the first range 24a.

Next, by the first conveyance operation, the printing medium A is conveyed forward by the first conveyance amount d1, and the nozzle range 24 is located at a position p2 with respect to the printing medium A. At the position p2, by the second (i.e., second cycle) first pass operation, ink is not ejected from the nozzles 21 in the third range 24c to the fourth range 24d, but ink is ejected from the nozzles 21 in the first range 24a to the second range 24b. In this way, the first pass image is formed in partial print areas c1 and c2 of the printing area C facing the first range 24a to the second range 24b. Therefore, the first-pass images by the first-pass operation of the first cycle to the second cycle are superimposed in the partial area c1.

Next, by the first conveyance operation, the printing medium A is conveyed forward by the first conveying amount d1, and the nozzle range 24 is located at a position p3 relative to the printing medium A in the front-rear direction. At the position p3, by the third (third cycle) first pass operation, ink is not ejected from the nozzles 21 of the fourth range 24d, but ink is ejected from the nozzles 21 of the first range 24a through the third range 24c. In this way, the first pass image is formed in the partial print areas c1 to c3 of the printing area C facing the first range 24a to the third range 24c. Therefore, in the partial region c1, the first pass images by the first pass operation of the first to third cycles are superimposed, and in the partial region c2, the first pass images by the first pass operation of the second to third cycles are superimposed.

Next, by the first conveyance operation, the printing medium A is conveyed forward by the first conveyance amount d1, and the nozzle range 24 is located at a position p4 with respect to the printing medium A. At the position p4, by the fourth (fourth cycle) first pass operation, ink is ejected from the nozzles 21 in the first range 24a through the fourth range 24d. In this way, the first pass image is formed in the partial areas c1 to c4 of the printing area C facing the first range 24a to the fourth range 24d. Therefore, in the partial area c1, the first pass images by the first cycle to fourth cycle first pass operation are superimposed, in the partial area c2, the first pass images by the second cycle to fourth cycle first pass operation are superimposed, and in the partial area c3, the first pass images by the third cycle to fourth cycle first pass operation are superimposed.

When multiple first-pass images are superimposed by the first printing process as described above, shingling is executed to distribute the dots that compose the first-pass image in the right-left direction. In the example in FIG. 3, the first pass operation of the first cycle is paired with the first pass operation of the third cycle, and the first pass operation of the second cycle is paired with the first pass operation of the fourth cycle, and shingling is executed on each pair.

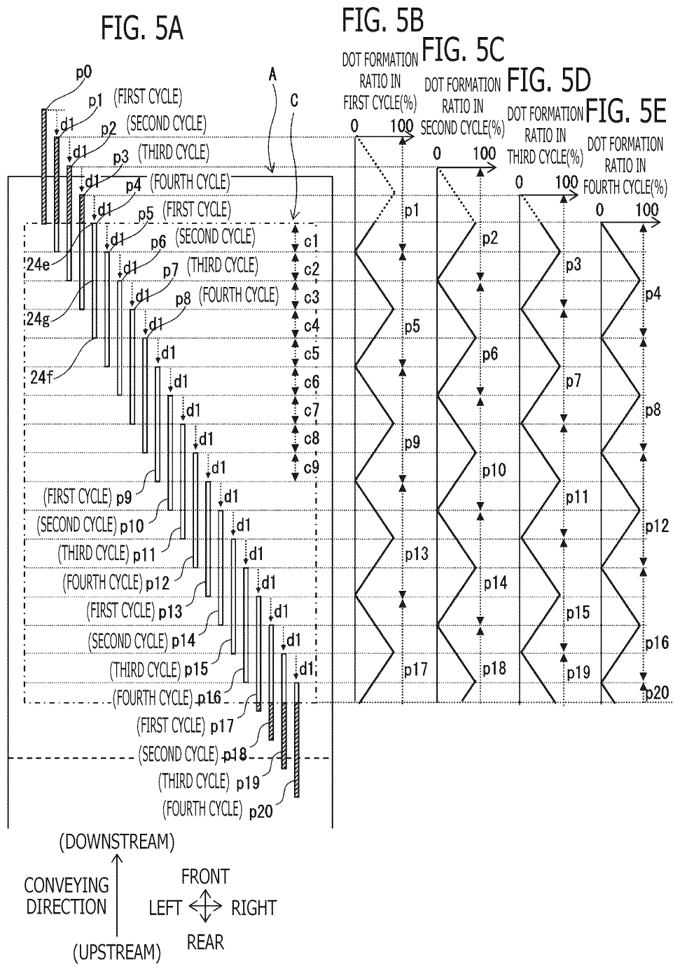

According to FIG. 5A, which shows a position of the nozzle range 24 relative to the printing area C in FIG. 3, the first pass operation of the first cycle is executed when the nozzle range 24 is located at a position p (4n-3) (n being a natural number), for example, p1, p5, p9, p13, and p17. The first pass operation of the second cycle is executed when the nozzle range 24 is located at a position p (4n-2), e.g., p2, p6, p10, p14, p18. The first pass operation of the third cycle is executed when the nozzle range 24 is located at a position p (4n-1), e.g., p3, p7, p11, p15, p19. The first pass operation of the fourth cycle is executed when the nozzle range 24 is located at a position p (4n), e.g., p4, p8, p12, p16, p20.

FIG. 5B shows a dot formation ratio formed by the first pass operation in the first cycle, FIG. 5C shows a dot formation ratio formed by the first pass operation in the second cycle, FIG. 5D shows a dot formation ratio formed by the first pass operation in the third cycle, and FIG. 5E shows a dot formation ratio formed by the first pass operation in the fourth cycle. One axis of a graph corresponding to the front-rear direction in FIG. 5A shows a position in the printing area C along the front-rear direction, and the other axis perpendicular to the one axis of the graph shows the percentage of dots formed (hereinafter, referred to as a dot formation ratio) (%).

The dot formation ratio (%) is calculated by a formula, Ns/Nt×100, where Ns represents the number s of dots that can be formed with being aligned in the right-left direction by the first pass operation in each cycle, and Nt represents the number t of dots that can be formed being aligned in the right-left direction by one pair of the first pass operations. In the shingling, the controller 60 distributes the dots formed by the first-pass operation of the cycles that make up a pair in the right-left direction. Therefore, the number t of dots represents the number of dots that can be formed by the first-pass operations of the first and the third cycles that make up a pair. The sum of the dot formation ratio by the first pass operation in the first cycle and the dot formation ratio by the first pass operation in the third cycle is 100%. Further, the number t of dots represents the number of dots that can be formed by the first pass operations of the second and the fourth cycles that form the pair. The sum of the dot formation ratio by the first pass operation in the second cycle and the dot formation ratio by the first pass operation in the fourth cycle is 100%.

FIG. 5B-FIG. 5E indicate that the dot formation ratio by a single first pass operation has a gradient that varies between 0 and 100 (%) by gradient shingling. For example, the dot formation ratio increases at a constant rate from 0 (%) to 100 (%) from the downstream end 24e of the nozzle range 24 to the middle 24g in the front-rear direction, and decreases at a constant rate from 100 (%) to 0 (%) from the middle 24g to the upstream end 24f of the nozzle range 24. Thus, in the front-rear direction, the dot formation ratio is set according to the position of the 21 nozzles in the nozzle range 24, not according to the position of the nozzle range 24 relative to the printing area C. Therefore, unevenness in image quality is reduced over the entire printing area C.

The dotted lines in each graph show the dot formation ratio corresponding to the non-ink discharge range (indicated by shading) in the nozzle range 24, while the solid lines show the dot formation ratio corresponding to the ink discharge range (indicated as a white range) in the nozzle range 24. In the first pass operations (the first pass operation at position p1, the second pass operation at position p2, and the third pass operation at position p3) in which printing is executed on the edge of the printing area C, the nozzle range 24 includes a non-ink-ejection range and an ink ejection range. For the nozzle range 24 of the first-pass operation as above, the dot formation ratio same as the dot formation ratio in other nozzle range 24 of the first-pass operation is also set. Therefore, since the dots are formed at the same ratio at the edges of the printing area C as in other parts of the print area C, unevenness in image quality can be reduced over the entire printing area C.

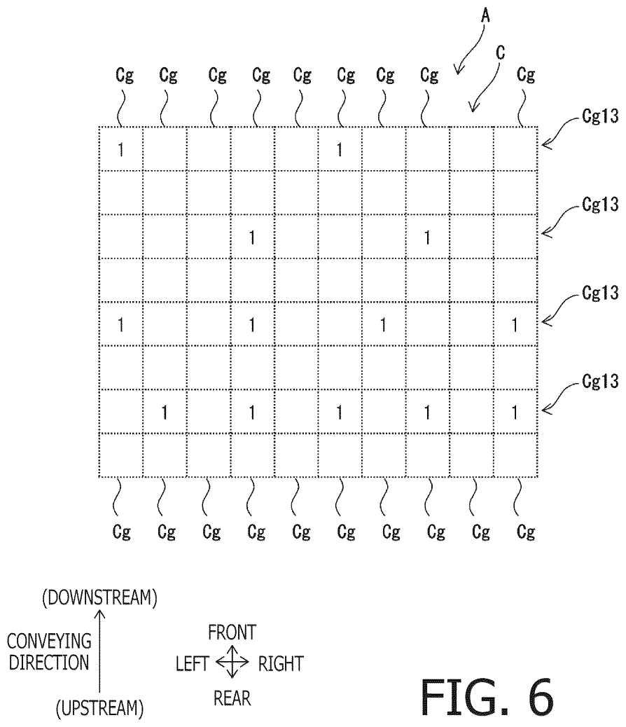

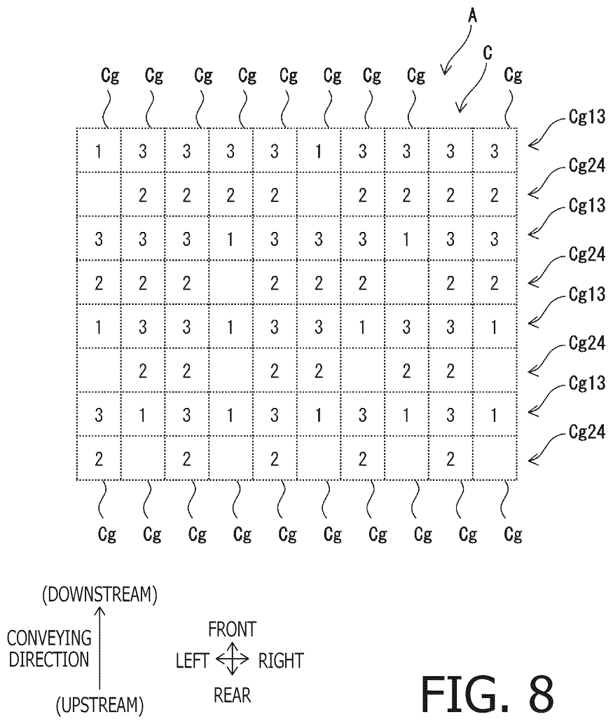

As shown in FIG. 6 to FIG. 9, a dot is formed in each pixel area Cg in the printing area C by the first pass operation. In the pixel area Cg indicated by “1” in FIG. 6, a dot is formed by the first pass operation in the first cycle, and in the pixel area Cg indicated by “3” in FIG. 8, a dot is formed by the first pass operation in the third cycle. Since the pixel area Cg “3” is placed between adjacent pixel areas Cg “1” in the right-left direction, dots are distributed in the right-left direction by the first pass operations in the first and third cycles.

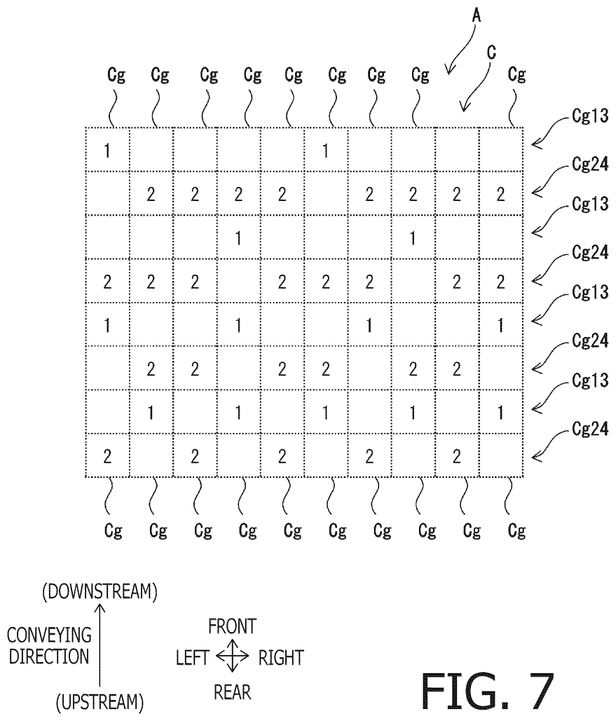

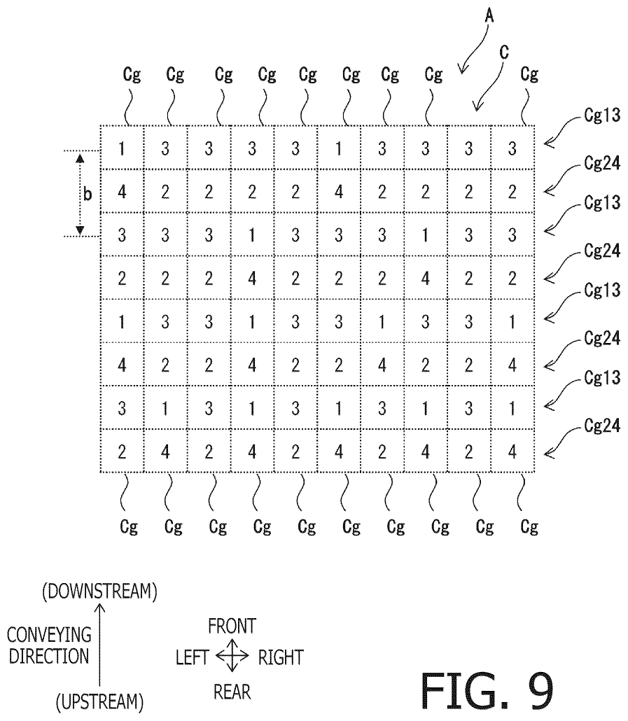

In the pixel area Cg indicated by “2” in FIG. 7, a dot is formed by the first pass operation in the second cycle, and in the pixel area Cg indicated by “4” in FIG. 9, a dot is formed by the first pass operation in the fourth cycle. Since the pixel area Cg “4” is arranged between two adjacent pixel areas Cg “2” in the right-left direction, the dots are distributed in the right-left direction by the first pass operations in the second and fourth cycles.

For the first printing process, where the resolution of the image in the front-rear direction is greater than the resolution of the head 20, an interlace method is used in which dots are formed by the current first pass operation at between the dot lines formed by the previous first pass operation in the front-rear direction.

As shown in FIG. 9, the pixel areas Cg “1” and Cg “3” are aligned right-left to form lines Cg13, and the pixel areas Cg “2” and Cg “4” are aligned right-left to form lines Cg24. Between adjacent two lines Cg13 of the pixel areas Cg (i.e., in spaces provided between the lines Cg13) in the front-rear direction, the lines Cg24 are provided. The space between two adjacent lines Cg13, or the space between two adjacent lines Cg24 is equal to a pitch b of the nozzles 21 in the conveying direction, a dot is formed at each of the pixel areas Cg. Therefore, the image can be printed by this head 20 even if the resolution of the image composed by the dots is larger than the resolution of the head 20 that is determined by the pitch b of the nozzles 21.

While executing the first printing process on the printing medium A as described above, a cutting process is executed to cut the printing medium A. As shown in FIG. 3, the controller 60 obtains a dimension a1 of the margin in the front-rear direction based on the printing conditions of the print job, and also obtains a dimension a2 between the downstream edge C1 and the upstream edge C2 of the printing area C in the front-rear direction based on the image data of the print job. Then, the controller 60 obtains a position where the sum of these dimensions (2×a1+a2) is added to a position A1 of the tip of the printing medium A as the cutting position A3. When the cutting position A3 reaches the cutter 51 (FIG. 1) at a particular position, the controller 60 executes the cutting process.

As shown in the example shown in FIG. 3, there could be a case where the cutting position A3 reaches the cutter 51 while the first conveyance operation is being executed in such a manner that the nozzle range 24 moves from the position p12 to the position p13 in the first printing process. In such a case, the printing medium A is conveyed by a conveyance amount d1a that is less than the first conveyance amount d1 in the first conveyance operation, and the first conveyance operation is terminated.

Then, the cutting process is executed with the nozzle range 24 stopped at a position p′ between the positions p12 and p13, and the cutting position A3 of the printing medium A is cut by the cutter 51. After this cutting process is executed, the first conveyance operation is resumed, and the printing medium A is conveyed by a conveyance amount d1b that is less than the first conveyance amount d1, and the nozzle range 24 moves from the position p′ to the position p13. Then, the first pass operation is executed and ink is ejected from the nozzle range 24 located at the position p13 onto the first pass area Fa (i.e., the area F12) of the printing medium A, forming dots in the first pass area Fa.

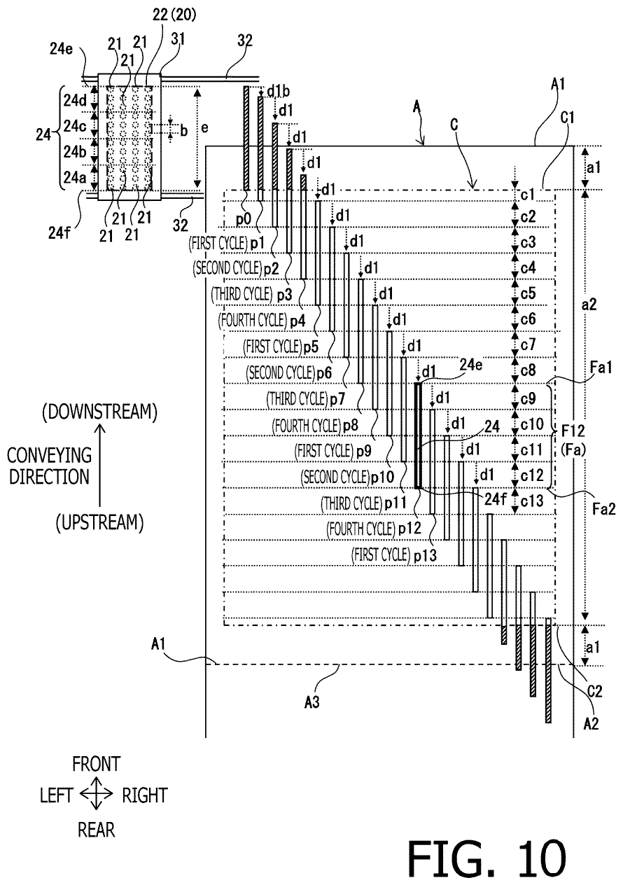

It is difficult to convey the printing medium A accurately for such a short conveyance amount d1a or d1b. Therefore, the position of the dot formed by the first pass operation after the cutting process may deviate from the desired position, resulting in poor image quality. Therefore, as shown in FIG. 10, a correction process is executed to correct the first conveying amount d1 in the first printing process in such a manner that the downstream end Fa1 in the conveying direction in the first pass area Fa is faced to the downstream end 24e in the nozzle range 24 in the conveying direction when the cutting process is to be executed.

The cutting process is performed after this correction process is performed. For example, the first conveyance amount d1 in at least one first conveyance operation included in the first printing process is corrected. In the following description, a case in which the first conveyance amount d1 of the first conveyance operation in the first printing process is corrected will be described.

It should be noted that the correction process is not necessarily limited to the above. For example, the first conveyance amount d1 of another first conveyance operation other than the first execution of the first conveyance operation in the first printing process may be corrected. Alternatively, the first conveyance amount d1 of multiple first conveyance operations in the first printing process may be corrected.

As described above, the first conveyance d1 is corrected in the first execution of the first conveyance operation in the first printing process. After the first execution of the first conveyance operation, a first execution of the first pass operation is executed. Thereafter, the first conveyance operation with the uncorrected first conveyance amount d1 and the first pass operation are alternately executed. In this way, the first pass images by all the first pass operations in the first printing process are formed at every constant first conveyance amount d1, thereby suppressing the degradation of image quality caused by the difference in the conveyance amount.

As shown in FIG. 10, the first execution of the first conveyance operation is the first execution of the first conveyance operation that is executed immediately after the execution of the alignment process. By the correction process, the first conveyance amount d1 of the first conveyance operation to be corrected is corrected to a conveyance amount d1b less than the first conveyance amount d1 of the other first conveyance operations. This corrected first conveyance amount d1b is less than the first conveyance amount d1 of the other first conveyance operation by an amount d1a(=d−d1b).

Immediately after the first execution of the first conveyance operation, the first execution of the first pass operation is executed, and ink is ejected from the nozzles 21 in the nozzle range 24 located at the position p1. For the first execution of the first conveyance operation, the ink ejection range (white range) within the nozzle range 24 at the position p1 is narrower when the correction process is executed (FIG. 10) than when the correction process is not executed (FIG. 3). Therefore, the number of nozzles 21 used in the first execution of the pass operation when the conveyance amount of the first execution of the first conveyance operation is corrected by the correction process (FIG. 10) is less than the number of nozzles 21 used in the first execution of the pass operation when it is not corrected by the correction process (FIG. 3). That is, the number of nozzles 21 used in the first pass operation immediately after the first conveyance operation when the first conveyance amount of the first conveyance operation is corrected by the correction process is less than the number of nozzles 21 used in the first pass operation when the first conveyance amount of the first conveyance operation is not corrected.

The correction process is executed on the first conveyance amount d1 of the first conveyance operation that is executed before the cutting process. As a result, the nozzle range 24 at the time of execution of the cutting process is shifted from the position p′, where no correction process has been executed, to the position p12 as shown in FIG. 3, and faces the first pass area Fa in the region F12. The downstream end 24e of the nozzle range 24 faces the downstream end Fa1 of the first pass area Fa, while the upstream end 24f of the nozzle range 24 faces the upstream end Fa2 of the first pass area Fa.

While the downstream end 24e of the nozzle range 24 is facing the downstream end Fa1 of the first pass area Fa, the printing medium A is not conveyed since, for example, the first pass operation is executed. By executing the cutting process while the printing medium A is stopped, an inter-pass conveyance operation, which is the first conveyance operation of the printing medium A between the first pass operations, is not interrupted due to the cutting process. Therefore, the conveyance amount of the printing medium A does not become less than the first conveyance amount d1 due to the interruption of the first conveyance operation, and the conveyance accuracy of the printing medium A is prevented from deteriorating. As a result, the occurrence of banding caused by the cutting processes of a long printing medium A can be suppressed.

An the example shown in FIG. 10, the controller 60 executes the correction for the first execution of the first conveyance operation in the first printing process. However, there are cases where the correction process is executed for a first conveyance operation other than the first execution of the first conveyance operation. In such a case, the first pass operations are executed before and after the first conveyance operation subject to the correction process. The first pass image formed by the first pass operation before the first conveyance operation and the first pass image formed by the first pass operation after the first conveyance operation are offset by the corrected first conveyance amount d1b. Since this corrected first conveyance d1b is less than the first conveyance amount d1, it is possible to prevent these first pass images from being widely spaced from each other.

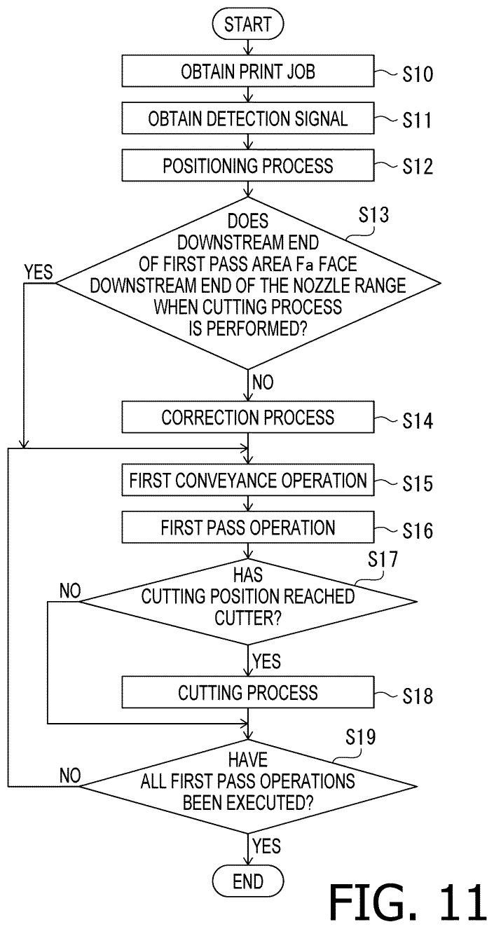

The printing apparatus 10 is controlled by the controller 60 according to a flowchart shown in FIG. 11, which illustrates an example of a control method. The controller 60 obtains a print job from the communication interface 63 or the storage 62 (S10) and further obtains detection signals from the conveyance sensor 48 and the encoder 46 of the conveyance motor 45 (S11).

Thereafter, the controller 60 performs a positioning process (S12). In the positioning process, the controller 60 obtains the downstream end C1 of the printing area C by adding a margin dimension a1 based on the printing conditions of the print job to the position of the leading edge A1 of the printing medium A based on the detection signals of the conveyance sensor 48 and the encoder 46 of the conveyance motor 45. Then, the control device 60 conveys the printing medium A in the front-rear direction in such a manner that the downstream end C1 faces the upstream end 24f of the nozzle range 24 of the head 20.

The controller 60 determines whether the downstream end Fa1 of the first pass area Fa faces the downstream end 24e of the nozzle range 24 when the cutting process is performed (S13). It is noted that the controller 60 shifts the position of the nozzle range 24 by the first transport amount d1 based on the printing conditions of the print job from the position p0 determined by the alignment process and obtains the position of the nozzle range 24 and the position of the first pass area Fa facing the nozzle range 24 each time. Further, the controller 60 obtains the cutting position A3, which is obtained by adding the dimension a1 of the margin and the dimension a2 of the printing area C based on the image data of the print job, to the position of the downstream end C1 of the printing area C. Then, the controller 60 obtains the position of the first pass area Fa facing the nozzle range 24 when the cutting position A3 reaches the cutter 51 during the execution of the first printing process, and determines whether the downstream end Fa1 of the first pass area Fa faces the downstream end 24e of the nozzle range 24.

If the downstream end Fa1 of the first pass area Fa does not face the downstream end 24e of the nozzle range 24 in S13 (S13: NO), the cutting process is performed during the execution of the first conveyance operation. To avoid the above, the controller 60 performs the correction process for the first conveyance amount d1 (S14). In this correction process, the controller 60 corrects the first conveyance amount d1 to the first conveyance amount d1b in such a manner that the downstream end Fa1 of the first pass area Fa1 faces the downstream end 24e of the nozzle range 24 when the cutting process is performed. In this way, the cutting process is performed without interrupting the first conveyance operation for the cutting process, while the first conveyance operation is not executed and the printing medium A is stopped. As a result, the positional misalignment of dots due to interruption of the first conveyance operation can be reduced, and the occurrence of banding caused by the cutting process of long printing medium A can be suppressed.

When the downstream end Fa1 of the first pass area Fa faces the downstream end 24e of the nozzle range 24 (S13: YES), or after execution of the correction process in S14, the controller 60 performs the first printing process. In this first printing process, the controller 60 executes the first conveyance operation and conveys the printing medium A by the first conveyance amount d1 that has not been corrected in S14, or by the first conveyance amount d1b that has been corrected by the correction process in S14 (S15). As a result, the nozzle range 24 moves from the position p0 according to the alignment process to the position p1. Then, the controller 60 executes the first pass operation (S16) and ejects ink from the nozzles 21 in the nozzle range 24 while moving the nozzle range 24 in the right-left direction at the position p1. In this way, dots are formed in the first pass area Fa facing the nozzle range 24, and the first pass image configured by the dots is formed.

The controller 60 determines whether the cutting position A3 of the printing medium A has reached the cutter 51 (S17). If the cutting position A3 of the printing medium A reaches the cutter 51 (S17: YES), the controller 60 performs the cutting process and cuts the printing medium A at the cutting position A3 with the cutter 51 (S18).

After the execution of the cutting process in S18, or if the cutting position A3 of the printing medium A has not reached the cutter 51 (S17: NO), the controller 60 determines whether all the first pass operations based on the print job have been executed (S19). If there are any remaining first pass operations that have not been executed (S19: NO), the controller 60 returns to S15 and executes subsequent processes. On the other hand, when all the first pass operations have been executed (S19: YES), the controller 60 terminates the process.

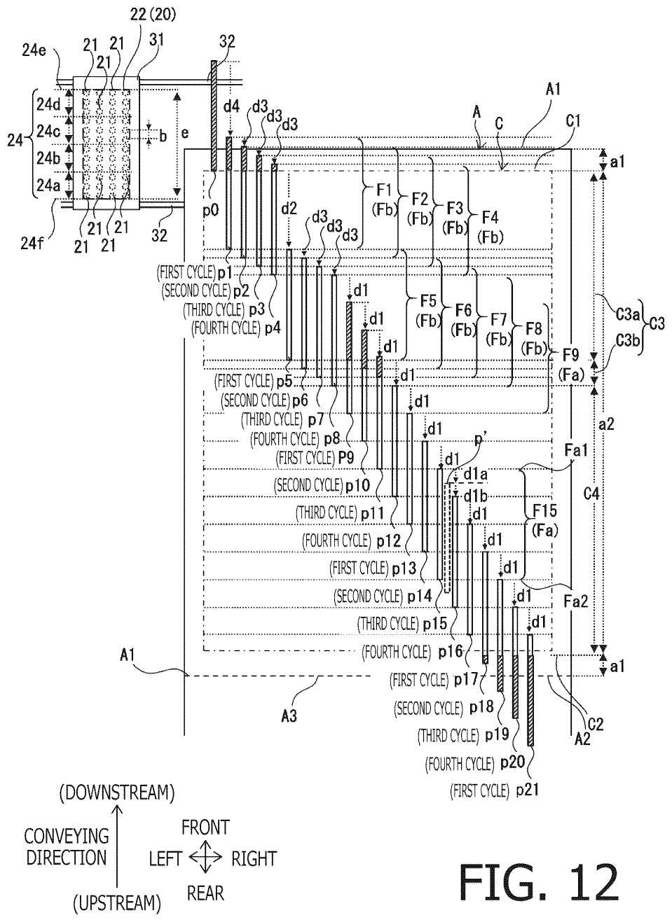

The printing apparatus 10 according to the present embodiment is configured to print the image on the printing medium A by the first printing process as shown in FIG. 3. In contrast, the printing apparatus 10 according to a modified embodiment is configured to print an image on the printing medium A by a second printing process that is performed before the first printing process, in addition to the first printing process, as shown in FIG. 12. The second printing process includes a second pass operation, by which ink is ejected in a second pass area Fb, which is a part of the printing area C, to form a second pass image. In the following description, the first and second pass operations are collectively referred to as pass operations, the first pass area Fa and the second pass area Fb are collectively referred to as pass areas, and the first and second pass images are collectively referred to as pass images.

The second printing process includes the second pass operation and the second conveyance operation, which are executed alternately. In the second pass operation, the controller 60 cause the head 20 to eject ink from the nozzles 21 of the head 20 to the second pass area Fb of the printing medium A, while moving the head 20 to the right or left. In the second conveyance operation, the controller causes the conveying device to convey the printing medium A by a particular conveyance amount. In this way, dots are formed in the second pass area Fb, forming a second pass image composed of dots. The second pass area Fb is the area of the printing medium A facing the nozzle range 24 of the head 20 in the second pass operation. Further, the second pass area Fb is an area where ink can be ejected from the nozzles 21 in the nozzle range 24 by one second pass operation. In the front-rear direction, the dimension of the second pass area Fb is equal to the dimension e of the nozzle range 24.

In the second conveyance operation, the controller 60 cause the conveying device 40 to convey forward the printing medium A with respect to the head 20 by a second conveyance amount d2, a third conveyance amount d3 or a fourth conveyance amount d4. The fourth conveyance amount d4 is a conveyance amount of the printing medium A by the first execution of the second conveyance operation in the second printing process after the alignment process. The third conveyance amount d3 is set to be less than the first conveyance amount d1, in such a manner that a part of the second pass area Fb subject to the current second pass operation overlaps on a part of the second pass area Fb subject to the previous second pass area Fb. The second conveyance amount d2 is defined to be longer than the first conveyance amount d1 and is based on the position of the leading end A1 of the printing medium A relative to the upstream roller 43 and the downstream roller 44, as shown in FIG. 1.

As shown in FIG. 1, since the printing medium A is drawn from the roll body Ar, on which the printing medium A is rolled, the drawn part of the printing medium A has a tendency to be curled. Therefore, when the printing medium A curls, depending on the position of the leading end A1 (FIG. 3) of the printing medium A, the leading end A1 may contact the ejection surface 22 of the head 20 and the printing medium A may be contaminated. The second conveyance amount d2 is set such that the second pass operation is not performed at a position where the printing medium A tends to contact the ejection surface 22.

When the leading end A1 of the printing medium A is located downstream of a holding position j1 of the upstream roller pair 43 and upstream of a holding position j2 of the downstream roller pair 44, the printing medium A is held only by the upstream roller pair 43 and is not held by the downstream roller pair 44. In such a state, the leading end A1 of the printing medium A is located between the ejection surface 22 and the platen 11 in the up-down direction, and when the printing medium A is being curled, the leading end A1 contacts the ejection surface 22.

In such a case, however, if the leading end A1 of the printing medium A is located between the holding position j1 and a particular position j4 that is downstream of the holding position j1 by a particular dimension j3, the dimension of the printing medium A extending downstream from the holding position j1 is less than the dimension j3. Therefore, in such a case, the leading end A1 is unlikely to contact the ejection surface 22 owing to the tension of the printing medium A. Therefore, while the leading end A1 is located between the holding position j1 and the particular position j4, the second pass operation and the second conveyance operation, in which the medium A is conveyed by the third conveyance amount d3, are alternately executed on the printing medium A.

When the printing medium A is conveyed and its leading end A1 is located between the particular position j4 and the holding position j2, a dimension of the printing medium A extending upstream from the holding position j1 is longer than a particular dimension j3. In such a case, the curled leading end A1 of the printing medium A may contact the ejection surface 22. Therefore, when the leading end A1 of the printing medium A is located between the holding position j1 and the particular position j4, the second pass operation is not executed for the printing medium A, but the second conveyance operation is executed to convey the printing medium A by the second conveyance amount d2, which corresponds to the interval j5 between the holding position j1 and the particular position j4.

When the printing medium A is conveyed and a leading end A1 of the printing medium A is located downstream of the particular position j4, the printing medium A is held by the upstream roller pair 43 and the downstream roller pair 44, and it is unlikely that the leading end A1 of the printing medium A contacts the ejection surface 22. Therefore, the second pass operation and the second conveyance operation, in which the printing medium A is conveyed by the third conveyance amount d3, are executed alternately. After the second printing process, the first printing process is executed, and the first conveyance operation and the first pass operation are executed alternately.

The cycle of the multi-pass method in the second printing process is set by (resolution of image/resolution of head 20 x number of shinglings) as in the first printing process, and is 4 cycles in the example shown in FIG. 12. In this case, the second pass operation of the second printing process is executed when the nozzle range 24 is located at each of the positions p1 to p8, and the first pass operation of the first printing process is executed when the nozzle range 24 is located at each of the positions p9, p10, p1, . . .

Among such cases, when the nozzle range 24 is located at the position p (4n-3) (n being a natural number), the first or second pass operation of the first cycle is executed. When the nozzle range 24 is located at the position p (4n-2), the first or second pass operation of the second cycle is executed. When the nozzle range 24 is located at the position p (4n-1), the first or second pass operation of the third cycle is executed. When the nozzle range 24 is located at the position p (4n), the first or second pass operation of the fourth cycle is executed.

For example, after the nozzle range 24 is aligned at the position p0 by the alignment process, the first execution of the second conveyance operation of the second printing process is executed, thereby the printed medium A being conveyed forward by the fourth conveyance amount d4, and the nozzle range 24 being moved from the position p0 to the position p1. The second pass operation of the first cycle is executed, and ink is ejected from the 21 nozzles of the nozzle range 24 located at the position p1 to the second pass area Fb of the area F1 to form the second pass image.

Then, by the second execution of the second conveyance operation of the second printing process, the printing medium A is conveyed forward by a third conveyance amount, d3, and the nozzle range 24 is moved from the position p1 to the position p2. By the second pass operation of the second cycle, ink is ejected from the nozzles 21 in the nozzle range 24 located at the position p2 to the second pass area Fb in the region F2 to form the second pass image.

As described above, in the second printing process, the second conveyance operation and the second pass operation are repeated alternately. A second conveyance operation to convey the printing medium A by the third conveyance amount d3 is executed, and the nozzle range 24 moves to each of the positions p1 to p4. At each of these positions, the second pass operations of the first through fourth cycles are executed, and the second pass images are superimposed. Then, the second conveyance operation to convey the printing medium A by the second conveyance amount d2 is executed and the nozzle range 24 is moved from the position p4 to the position p5. Further, the second conveyance operation to convey the printing medium A by the third conveyance amount d3 is executed, and the nozzle range 24 is moved to each of the positions p5 to p8. At each of these positions, the second pass operation of the first through fourth cycles is executed, and these second pass images are superimposed.

After the last execution of the second pass operation of the second printing process, the first conveyance operation of the first printing process is executed, and the printed medium A is conveyed forward by the first conveyance amount d1, and the nozzle range 24 is moved from the position p8 to the position p9. The first pass operation of the first cycle is executed, and ink is ejected from the nozzles 21 of the nozzle range 24 located at the position p9 to the first pass area Fa of the area F9 to form the first pass image. As described above, in the first printing process, the first conveyance operation to convey the printing medium A by the first conveyance amount d1 and the first pass operation are repeated alternately.

As described above, in the printing area C, the pass images formed by the first or second pass operation in the first through fourth cycles are superimposed. In such a case, the printing area C has a downstream end part C3 and other parts C4 other than the downstream end part C3. The downstream end part C3 includes a downstream part C3a and an upstream part C3b, which is upstream of the downstream part C3a.

o this downstream part C3a, the second pass operation is executed without the first pass operation being executed, to the upstream part C3b, the first and second pass operations are executed, and to the other part C4, the first pass operation is executed without the second pass operation being executed. Therefore, the second printing process is executed on the downstream end part C3, including the downstream part C3a and the upstream part C3b. Four second pass images are superimposed in the downstream part C3a, four pass images are superimposed in the upstream part C3b, and four first pass images are superimposed in the other part C4.

Then multiple pass images are superimposed by the first and second printing processes, shingling is executed to distribute the dots that make up the pass image in the right-left direction. In the example shown in FIG. 12, the first cycle pass operation is paired with the third cycle pass operation, and the second cycle pass operation is paired with the fourth cycle pass operation, and shingling is executed on each pair.

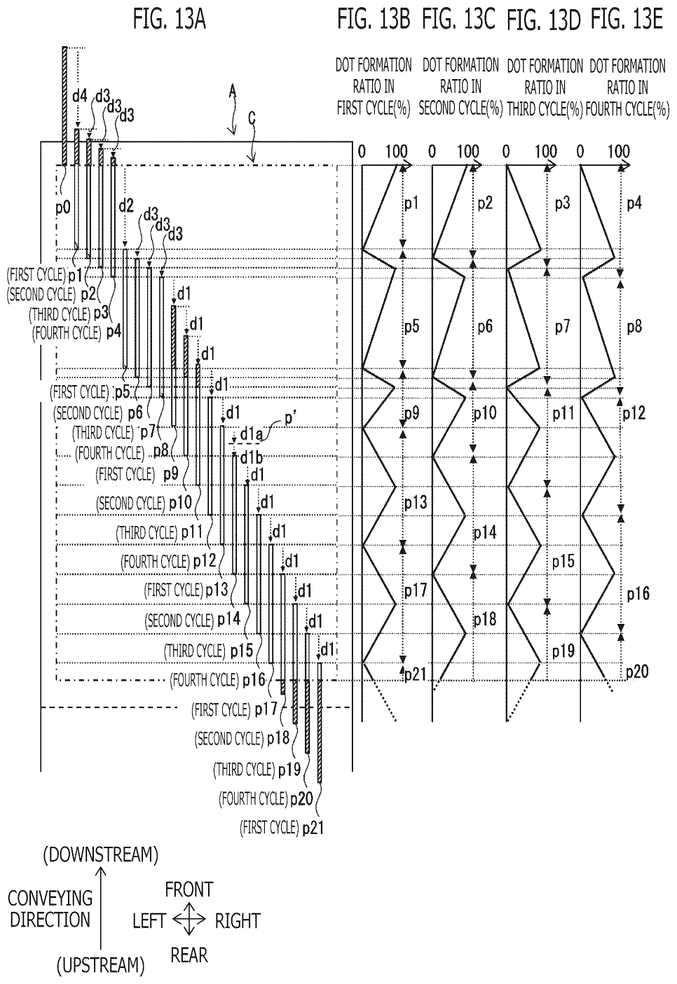

According to FIG. 13A, which shows the position of the nozzle range 24 relative to the printing area C in FIG. 12, the first cycle pass operation is executed when the nozzle range 24 is located at the position p (4n-3) (n being a natural number). The second cycle pass operation is executed when the nozzle range 24 is located at the position p (4n-2). The third cycle pass operation is executed when the nozzle range 24 is located at the position p (4n-1). The fourth cycle pass operation is executed when the nozzle range 24 is located at the position p (4n).

FIG. 13B shows the dot formation ratio in the first cycle of pass operations, FIG. 13C shows the dot formation ratio in the second cycle of pass operations, FIG. 13D shows the dot formation ratio in the third cycle of pass operations, and FIG. 13E shows the dot formation ratio in the fourth cycle of pass operations. In FIG. 13B-FIG. 13E, the dot formation ratio by a single first pass operation has a gradient that varies from 0 to 100 (%) by gradient shingling.

Similar to the first pass operation, dots are formed in the pixel areas Cg “1” to “4” by the second pass operation in the first through fourth cycles, respectively, as shown in FIG. 9. The line Cg13 of the pixel areas Cg “1” and Cg “3” aligned in the right-left direction, and the the line Cg24 of the pixel areas Cg “2” and Cg “4” aligned in the right-left direction are aligned in the front-rear direction. The lines Cg24 are provided at spaces formed between adjacent lines Cg13 in the front-rear direction. The distance between the adjacent lines Cg13 in this front-rear direction is equal to the pitch b of the nozzles 21, and dots are formed in each of these pixel areas Cg. As a result, even if the resolution of the image composed by the dots is larger than the resolution of the head 20 based on the pitch b of the nozzles 21, the image can still be printed by the head 20.

Thus, while the first and second printing processes are executed on the printing medium A, a cutting process is executed to cut the printing medium A. The controller 60 obtains the cutting position A3 from the printing conditions of the print job, and when the cutting position A3 reaches the cutter 51, the controller 60 causes the cutter 51 to cut the printing medium A at the cutting position A3. For example, as shown in FIG. 12, there may be a case where the cutting position A3 reaches the cutter 51 while the first conveyance operation is being executed in such a manner that the nozzle range 24 moves from the position p15 to the position p16 in the first printing process. In such a case, the first conveyance operation is interrupted and the cutting process is executed.

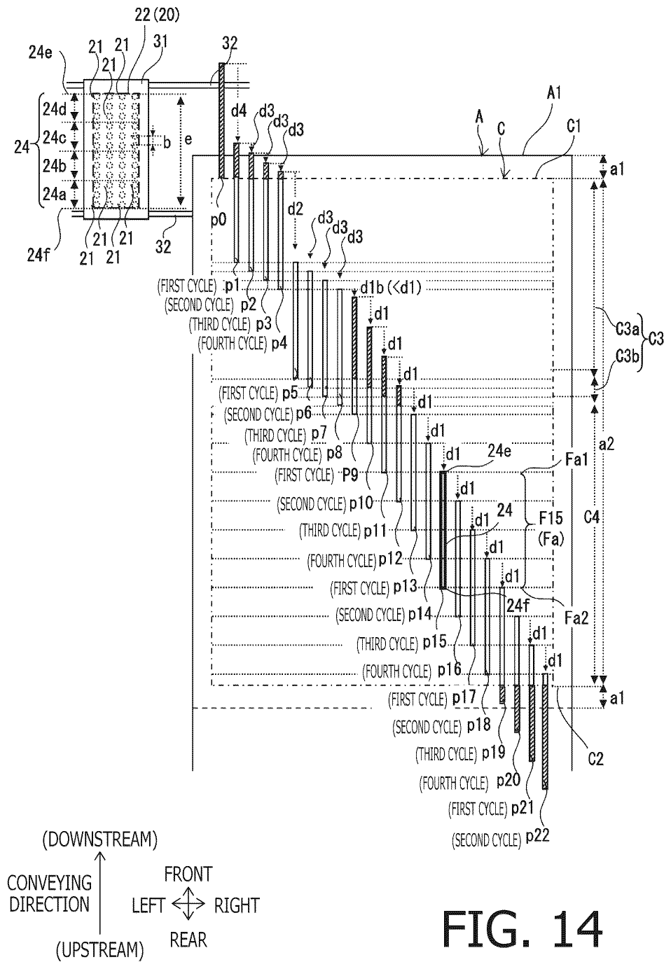

When the first conveyance operation is interrupted as described above, the conveyance amounts d1a and d1b before and after the interruption become less than the first conveyance amount d1, which may result in a decrease in conveyance accuracy and a decrease in image quality. Therefore, as shown in FIG. 14, a correction process is executed to correct the first conveying amount d1 in the first printing process in such a manner that the downstream end Fa1 in the conveying direction in the first pass area Fa is facing the downstream end 24e in the nozzle range 24 when the cutting process is executed. In this way, the first conveyance operation of the printing medium A is not executed during the cutting process, so the first conveyance operation is not interrupted for the cutting process, and banding caused by the cutting process can be suppressed.

The correction process is executed with respect to the first conveyance amount d1 in at least one first conveyance operation included in the first printing process. In the following description, the correction process for correcting the first conveyance amount d1 of the first conveyance operation is explained, but the correction process is not necessarily limited to this. For example, the first conveyance amount d1 of other first conveyance operations (i.e., other than the first conveyance operation) may be corrected. Alternatively, the first conveyance amount d1 of multiple first conveyance operations may be corrected. It should be noted, however, that in any case, the correction process is executed prior to the cutting process. By this correction process, the first conveyance amount d1 of the first conveyance operation executed before the cutting process is corrected.

As shown in FIG. 14, for example, the correction process corrects the first conveyance amount d1 in the first execution of the first conveyance operation in the first printing process. This first execution of the first conveyance operation is the first conveyance operation executed immediately after the execution of the second pass operation of the second printing process. This means that all first pass operations are executed after the first execution of the first conveyance operation subject to the correction process. Therefore, since all the first pass images in the first printing process are formed at every constant first conveyance amount d1, the image quality degradation caused by the difference in conveyance amount can be suppressed.

Further, the correction process corrects the first conveyance amount d1 to be corrected to a conveyance amount d1b that is less than the other first conveyance amounts d1. According to this configuration, it is possible to prevent a wide gap between the first pass images formed by the first pass operations before and after the first conveyance operation subject to the correction. When the correction process is executed for the first execution of the first conveyance operation in the first printing process as shown in FIG. 14, the ink ejection range (white range) of the nozzle range 24 at the position p9 is narrower than when the correction process is not executed as shown in FIG. 12. Therefore, the number of nozzles 21 used in the first execution of the first pass operation when the first conveyance amount d1 of the first conveyance operation is corrected by the correction process as shown in FIG. 14 is less than the number of nozzles 21 used in the first execution of the first pass operation when the first conveyance amount d1 of the first conveyance operation is not corrected by the correction process as shown in FIG. 12.

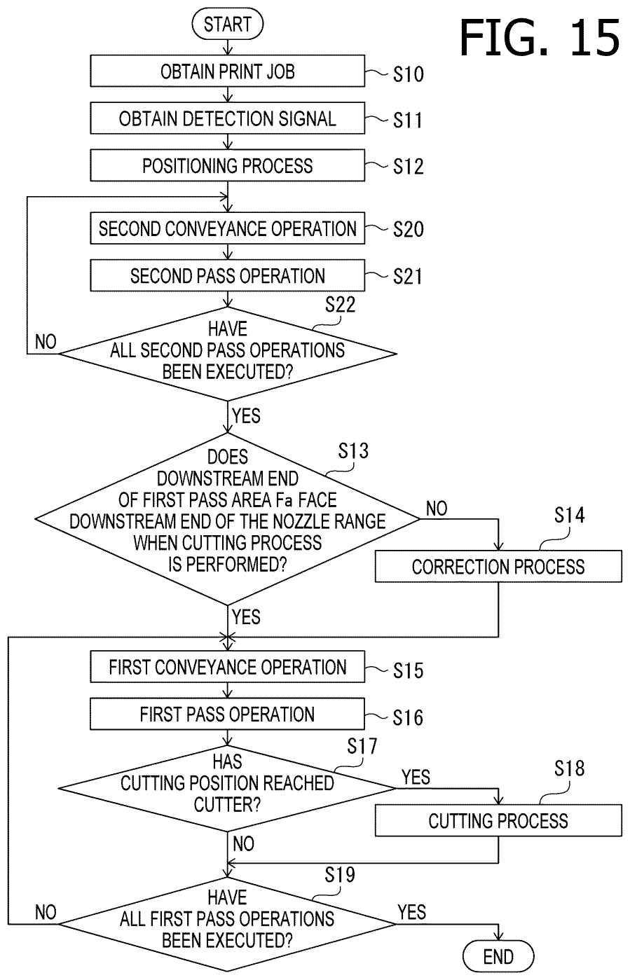

The printing apparatus 10 is controlled by the controller 60 according to the flowchart shown in FIG. 15, which is an example of a control method. In the flowchart of FIG. 15, steps S20-S22 are executed between steps S12 and S13 in the flowchart of FIG. 11.

Concretely, the controller 60 obtains a print job from the communication interface 63 or the storage device 62 (S10) and obtains detection signals from the conveyance sensor 48 and the encoder 46 of the conveyance motor 45 (S11). Then, the controller 60 executes the alignment process based on the print job and the detection signal (S12), and then executes the second printing process. In the second printing process, the controller 60 executes the second conveyance operation with the second conveyance amount d2 or the third conveyance amount d3 (S20) and then executes the second pass operation (S21).

In the second pass operation, the controller 60 causes the head 20 to eject ink from the nozzles 21 in the nozzle range 24 while moving the nozzle range 24 in the right-left direction. As a result, dots are formed in the second pass area Fb facing the nozzle range 24, and a second pass image composed of dots is formed. Then, the controller 60 determines whether all the second pass operations based on the print job have been executed (S22). If there remain second pass operations that have not been executed (S22: NO), the controller 60 returns to the process of S20 and executes subsequent processes.

On the other hand, after all the second pass operations are executed (S22: YES), the controller 60 determines whether the downstream end Fa1 of the first pass area Fa faces the downstream end 24e of the nozzle range 24 when the cutting process is to be executed (S13). If the downstream end Fa1 of the first pass area Fa does not face the downstream end 24e of the nozzle range 24 (S13: NO), the cutting process is executed during the execution of the first conveyance operation. To avoid such a situation, the controller 60 executes a correction process for the first conveyance amount d1 (S14). Then, the controller 60 executes the first printing process and the cutting process based on the print job (S15-S19).

In the above embodiments, bi-directional printing, in which the first pass operation in which the head 20 ejects ink while moving to the right and the first pass operation in which the head 20 ejects ink while moving to the left are alternately repeated, has been described. However, the printing method may be one-directional printing, in which head 20 does not eject ink while moving to one of the right and left, but instead ejects ink while head 20 moves to the other of the right and left.

The above embodiments may be combined with each other as long as they do not exclude each other's counterparts. Further, from the above description, many improvements and other embodiments of the present disclosure are apparent to those skilled in the art. Therefore, the above description should be interpreted only as an example and is provided for the purpose of teaching those skilled in the art the best ways to implement the present disclosure. The details of its structure and/or function can be substantially changed without departing from the spirit of the present disclosure.

What is claimed is:

1. A printing apparatus, comprising:
a supply tray configured to supply a printing medium;
a head having an ejection surface including a nozzle range in which a plurality of nozzles configured to eject ink toward the printing medium are arranged;
a moving device configured to move the head in a moving direction;
a conveying device configured to convey the printing medium along a conveying direction which intersects with the moving direction;
a cutter arranged closer to the supply tray with respect to the head, the cutter being configured to cut the printing medium; and
a controller,
wherein the controller is configured to perform:
a first printing process of repeatedly executing a recording process including a first pass operation and a first conveyance operation, the first pass operation being an operation of causing the plurality of nozzles to eject ink to a first pass area of the printing medium while causing the moving device to move the head along the moving direction, the first conveyance operation being an operation of causing the conveying device to convey the printing medium by a first conveyance amount less than or equal to a dimension of the nozzle range in the conveying direction, a part of a first pass area subject to the first pass operation in a current recording process overlapping a part of the first pass area subject to the first pass operation in a previous recording process;
a cutting process of cutting the printing medium by the cutter; and
a correction process of correcting the first conveyance amount in the first printing process in such a manner that a downstream end of the first pass area in the conveying direction faces a downstream end of the nozzle range in the conveying direction when performing the cutting process;
wherein the cutter is configured to cut the printing medium after the correction process is performed.

2. The printing apparatus according to claim 1,
wherein the controller is configured to perform:
a second printing process of executing a second pass operation and a second conveyance operation, the second pass operation being an operation of causing the plurality of nozzles to eject ink to a second pass area of the printing medium for a downstream end part of a printing area of the printing medium while causing the moving device to move the head along the moving direction, the second conveyance operation being an operation of causing the conveying device to convey the printing medium by a second conveyance amount larger than the first conveyance amount,
wherein the first printing process is executed after the second printing process is executed, and
wherein the correction process is executed with respect to the first conveyance amount in at least one of the first conveyance operations included in the first printing operation.

3. The printing apparatus according to claim 2,
wherein the correction process is executed with respect to the first conveyance amount in first execution of the first conveyance operations included in the first printing operation.

4. The printing apparatus according to claim 2,
wherein the first conveyance amount subject to the correction process is corrected to a conveyance amount less than the other first conveyance amounts.

5. The printing apparatus according to claim 2,
wherein the number of nozzles used in the first pass operation immediately after the first conveyance operation when the first conveyance amount of the first conveyance operation is corrected by the correction process is less than the number of nozzles used in the first pass operation when the first conveyance amount of the first conveyance operation is not corrected.

6. The printing apparatus according to claim 1,
wherein the controller is configured to perform:
an alignment process of aligning a downstream end of a printing area of the printing medium with an upstream of the nozzle range in the conveyancing direction,
wherein the first printing process is executed after the alignment process is executed, and
wherein the correction process is executed with respect to the first conveyance amount in at least one of the first conveyance operations included in the first printing operation.

7. The printing apparatus according to claim 6,
wherein the correction process is executed with respect to the first conveyance amount in first execution of the first conveyance operations included in the first printing operation.

8. The printing apparatus according to claim 6,
wherein the first conveyance amount subject to the correction process is corrected to a conveyance amount less than the other first conveyance amounts.

9. The printing apparatus according to claim 6,
wherein the number of nozzles used in the first pass operation immediately after the first conveyance operation when the first conveyance amount of the first conveyance operation is corrected by the correction process is less than the number of nozzles used in the first pass operation when the first conveyance amount of the first conveyance operation is not corrected.

10. A method of controlling a printing apparatus,
wherein the printing apparatus comprises:
a supply tray configured to supply a printing medium;
a head having an ejection surface including a nozzle range in which a plurality of nozzles configured to eject ink toward the printing medium are arranged;
a moving device configured to move the head in a moving direction;
a conveying device configured to convey the printing medium along a conveying direction which intersects with the moving direction;
a cutter arranged closer to the supply tray with respect to the head, the cutter being configured to cut the printing medium; and
a controller,
wherein the method of controlling the printing apparatus comprises:
a first printing process of repeatedly executing a recording process including a first pass operation and a first conveyance operation, the first pass operation being an operation of causing the plurality of nozzles to eject ink to a first pass area of the printing medium while causing the moving device to move the head along the moving direction, the first conveyance operation being an operation of causing the conveying device to convey the printing medium by a first conveyance amount less than or equal to a dimension of the nozzle range in the conveying direction, a part of a first pass area subject to the first pass operation in a current recording process being overlapping a part of the first pass area subject to the first pass operation in a previous recording process;
a cutting process of cutting the printing medium by the cutter; and
a correction process of correcting the first conveyance amount in the first printing process in such a manner that a downstream end of the first pass area in the conveying direction faces a downstream end of the nozzle range in the conveying direction when performing the cutting process;
wherein the cutting process is executed after the correction process is performed.

11. A non-transitory computer-readable recording medium containing computer-executable instructions that are executable by a controller of a printing apparatus,
wherein the printing apparatus comprises:
a supply tray configured to supply a printing medium;
a head having an ejection surface including a nozzle range in which a plurality of nozzles configured to eject ink toward the printing medium are arranged;
a moving device configured to move the head in a moving direction;
a conveying device configured to convey the printing medium along a conveying direction which intersects with the moving direction; and
a cutter arranged closer to the supply tray with respect to the head, the cutter being configured to cut the printing medium;
wherein the computer-executable instructions is configured to, when executed by the controller, cause the printing apparatus to perform:
a first printing process of repeatedly executing a recording process including a first pass operation and a first conveyance operation, the first pass operation being an operation of causing the plurality of nozzles to eject ink to a first pass area of the printing medium while causing the moving device to move the head along the moving direction, the first conveyance operation being an operation of causing the conveying device to convey the printing medium by a first conveyance amount less than or equal to a dimension of the nozzle range in the conveying direction, a part of a first pass area subject to the first pass operation in a current recording process overlapping on a part of the first pass area subject to the first pass operation in a previous recording process;
a cutting process of cutting the printing medium by the cutter; and
a correction process of correcting the first conveyance amount in the first printing process in such a manner that a downstream end of the first pass area in the conveying direction faces a downstream end of the nozzle range in the conveying direction when performing the cutting process;
wherein the cutting process is executed after the correction process is performed.
